(19) United States
(12) Patent Application Publication
(10) Pub. No.: US 2025/0109037 A1
(43) Pub. Date: Apr. 3, 2025

(54) PROCESSES AND SYSTEMS FOR PRODUCING A NICKEL SULFATE PRODUCT

(71) Applicant: BASF SE, Ludwigshafen am Rhein (DE)

(72) Inventors: Sabine Frischhut, Ludwigshafen (DE); Julia Hofinger, Ludwigshafen (DE); Ralf Boehling, Ludwigshafen (DE); Stefan Pichlmair, Iselin, NJ (US)

(73) Assignee: BASF SE, Ludwigshafen am Rhein (DE)

(21) Appl. No.: 18/702,353

(22) PCT Filed: Oct. 4, 2022
(86) PCT No.: PCT/EP2022/077572

§ 371 Date: Apr. 18, 2024

Related U.S. Application Data
(60) Provisional application No. 63/262,927, filed on Oct. 22, 2021.

(30) Foreign Application Priority Data
Oct. 27, 2021 (EP) 21205128.8

(51) Int. Cl. C01G 53/10

(52) U.S. Cl. CPC C01G 53/10; C01P 2006/80

(57) ABSTRACT

The present disclosure is directed to methods and systems for reacting elemental nickel particles with sulfuric acid and hydrogen peroxide solutions to produce nickel sulfate products, for example, nickel sulfate products suitable for battery materials.

### FIELD OF THE INVENTION

The present disclosure is directed to methods and systems for reacting elemental nickel particles with sulfuric acid and hydrogen peroxide solutions to produce nickel sulfate products, for example, nickel sulfate products suitable for battery materials.

### BACKGROUND

Nickel sulfate is useful for a number of applications such as, for example, as a source of electrode material for nickel-hydrogen and lithium-ion batteries. These types of batteries find use in hybrid electric cars, mobile phones, personal computers, and the like. They are therefore increasingly in demand, especially over the past decade and this need continues to grow at a high rate.

One method of producing nickel sulfate is by dissolving elemental nickel particles in sulfuric acid. This process requires a secure environment as volatile hydrogen gas is produced during the process, creating a hazardous environment. Additionally, the process of dissolving elemental nickel particles in aqueous solutions of acids is often impractically slow in most non-oxidizing acids and even in some oxidizing acids under certain conditions.

CN 111 439 791 A discloses a method for producing nickel sulfate by gas-liquid emulsification. Metallic nickel is dissolved with sulfuric acid by adopting an air oxidation method to produce nickel sulfate. A fixed bed reactor is filled with a deoiled and activated metal nickel block, and a proper amount of desalted water is supplemented; a gas-liquid mixing pump is opened, a solution is sucked from a bottom solution and mixed with pure oxygen to prepare an emulsion gas-liquid mixed solution, and the emulsion gas-liquid mixed solution is pumped into the reactor from the lower part of the fixed bed; meanwhile, sulfuric acid is slowly added, it is guaranteed that the pH value in the reactor is controlled to be 1.0 or below, and a continuous reaction is conducted; and when acid adding is completed and the pH value reaches a certain value, the reaction is stopped, and the reaction solution is filtered to obtain a pure nickel sulfate solution.

GB 2 104 053 A discloses a process for the production of nickel and cobalt sulfates and chlorides. Nickel or cobalt sulfate or chloride is prepared by dissolving pieces of the respective metal having a surface area not exceeding 0.5 m²/kg in hot sulfuric or hydrochloric acid and cooling the salt solution below 30° C. to crystallize the salt.

There is a need for alternative methods and systems to produce nickel sulfate products in a cost effective and safe manner, particularly nickel sulfate products that are suitable for use as raw materials for battery production.

### SUMMARY OF THE INVENTION

The present disclosure is directed to methods and systems for reacting elemental nickel particles with sulfuric acid and hydrogen peroxide solutions to produce nickel sulfate products, and for example, nickel sulfate products suitable for battery materials. In the present disclosure, it was surprisingly found that nickel sulfate products can be produced without the use of complex mechanical stirring devices.

### BRIEF DESCRIPTION OF THE DRAWINGS

FIG. 1a is a diagrammatic representation of an embodiment of the present disclosure for producing a nickel sulfate product.

FIG. 1b is a diagrammatic representation of another embodiment of the present disclosure for producing a nickel sulfate product.

FIG. 2 is a diagrammatic representation of a further embodiment of the present disclosure for producing a nickel sulfate product.

### DETAILED DESCRIPTION

The present disclosure provides for a method for preparing a nickel sulfate product. The method includes introducing nickel particles from a handling device into a vessel. The vessel of the present disclosure comprises a separation device therein, which controls the flow of the nickel particles through the vessel, when they are of suitable size to pass through the separation device. The method also includes using an external circulation loop for circulating the reaction mixture out of one end of the vessel and back into an opposite end of the vessel.

The method includes a sulfuric acid solution and a hydrogen peroxide solution. The method may be carried out at a temperature ranging from about 40° C. to about 200° C. The process uses elemental nickel particles, which may be in a form chosen from pellets, rounds, cathodes, briquettes, powders, and combinations thereof.

The process of the present disclosure may be carried out at a pressure above ambient pressure and under an inert atmosphere. The inert atmosphere may be chosen from hydrogen, water vapor, nitrogen, argon, and combinations thereof. The process may also be carried out at ambient pressure. The process may further include a secondary vessel for further processing of the nickel sulfate solution produced in the reaction vessel.

The nickel sulfate product may have a Ni²⁺ concentration ranging from 70 g/l to 200 g/l and a pH ranging from 0 to 2. The nickel sulfate product may have a pH ranging from 2 to 4. The nickel sulfate solution may be filtered to produce the nickel sulfate product which may be suitable for use without further purification. The nickel sulfate product may be passed over activated carbon or heated to remove residual hydrogen peroxide and/or subjected to selective ion exchange with, for example, with an iminodiacetic acid, an aminophosphonic acid or an aminomethylphosphonic acid based ion exchange to remove Fe³⁺ ions.

The present disclosure also provides for a system for preparing a nickel sulfate product. The system also includes a handling device for introducing the nickel particles into the vessel; gas inlets for introducing an inertization gas, and liquid inlets for introducing a sulfuric acid and/or hydrogen peroxide solutions into the vessel. The system includes a vessel with a separation device therein. The separation device controls the flow of nickel particles therethrough when the nickel particles are of suitable sizes. The system also includes an external circulation loop for circulating the reaction mixture out one end of the vessel and into an opposite end.

As used herein, “a” or “an” entity refers to one or more of that entity, e.g., “a vessel” refers to one or more vessels or at least one vessel unless stated otherwise. As such, the terms “a” (or “an”), “one or more”, and “at least one” are used interchangeably herein.

As used herein, the term “ambient pressure” means the pressure of the surrounding air and external environment where the system and/or process of the present disclosure is being carried out. The ambient pressure is typically atmospheric pressure.

As used herein, the term “inert atmosphere” means a gaseous environment that is non-reactive in the systems and processes of the present disclosure. For example, inert atmospheres are substantially oxygen free environments that primarily consist of non-reactive gases. Exemplary non-reactive gases include, for example, nitrogen and argon.

As used herein, the term “vessel” means a structure defining a volume that is suitable for containing one or more process components, including gases, liquids, solids, and mixtures thereof. Vessels of the present disclosure may be constructed of any suitable material, with non-limiting examples of such materials including glass, elemental metals, metal alloys, plastic, laminate, ceramics, glass fiber reinforced plastics (GFRPs), or any combination thereof. The vessels may be open to the environment or closed to operate under pressure. Vessels described herein are further configured to include one or more inlets and outlets for receiving and/or releasing components of the processes of the present disclosure.

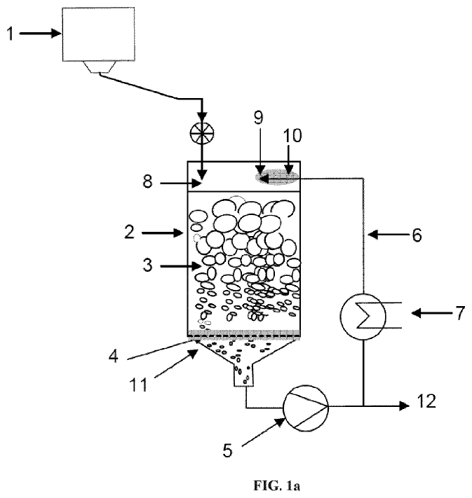

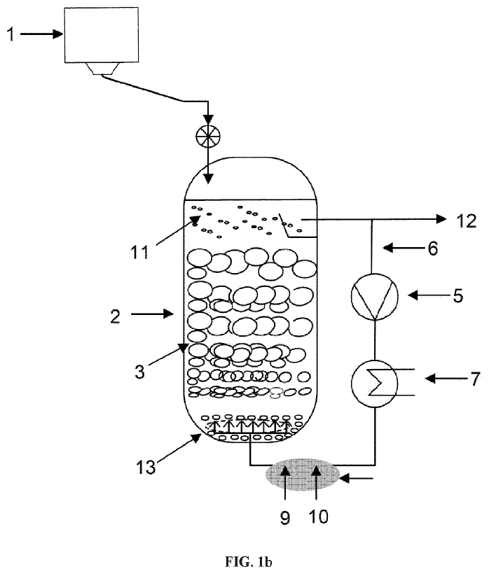

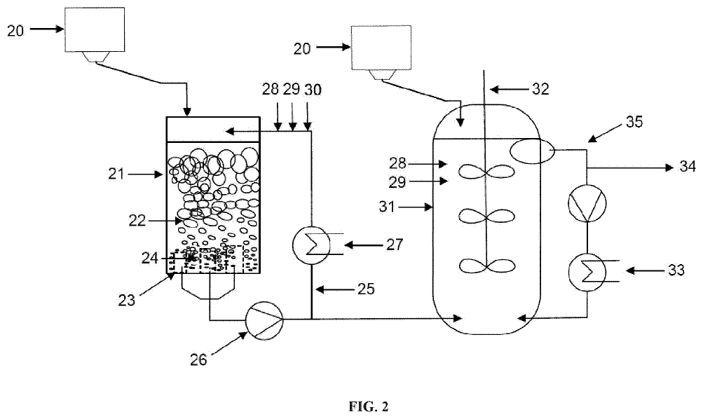

In the present disclosure, and as depicted in the accompanying drawings (FIGS. 1a, 1b, and 2), nickel leaching to manufacture a nickel sulfate product is carried out in a vessel, such as a column. A handling device is used to introduce nickel particles into the vessel. The nickel particles are packed into the reactor as a fixed-bed configuration and sulfuric acid and hydrogen peroxide solutions are introduced into the vessel, either separately (e.g., sequentially or continuously) or as a pre-mixture, and flow through the bed of nickel metal particles to allow for leaching of the particles to form a nickel sulfate slurry and a nickel sulfate solution.

The separation device in the vessel of the present disclosure comprises, e.g., a plate with orifices, a grid, a sieve, a filtering device, a packed bed of solids, a filter candle, a weir, a lamellar separator, or any combination thereof, to hold back larger nickel particles, while allowing smaller nickel particles to pass through. The larger nickel particles can further react with the sulfuric acid and hydrogen peroxide solutions to form further nickel sulfate slurry and/or nickel sulfate solution thereby reducing in size so as to eventually pass through the separation device.

The nickel sulfate slurry and/or the nickel sulfate solution are continuously circulated from one end of the vessel through an external circulation loop and using one or more pumps and to an opposite end of the vessel. This operation can help maintain, e.g., dispersion of the nickel particles in the nickel sulfate solution, aid in mixing the reaction mixture, aid heat control, or any combination thereof. The nickel sulfate slurry, nickel sulfate solution, or any combination thereof, can be transferred to a secondary vessel for further processing before the nickel sulfate product is collected.

Finally, the nickel sulfate solution is cooled to about 50° C. using, for example, a heat exchanger (air cooler) and then passed through a filter, such as a cross flow filter, to remove fine particles remaining. The filtered solution can then be passed over activated carbon or heated to remove unreacted hydrogen peroxide. The nickel sulfate product can also be subjected to ion exchange to remove Fe³⁺ ions. The nickel sulfate product can then be passed into a storage tank and stored. The nickel sulfate product of the present disclosure can be produced to have a predetermined nickel concentration and pH specification.

The process is carried out under an inert atmosphere, under ambient pressure and at temperatures of between 40° C. and 200° C. In some embodiments, the process is carried out at a temperature of between 50° C. and 120° C.

The following description provides the various embodiments of the different aspects of the disclosed methods and systems for reacting elemental nickel particles with sulfuric acid and hydrogen peroxide solutions to provide nickel sulfate products, and for example, nickel sulfate products suitable for battery materials productions.

### Processes

The present disclosure provides for a method for preparing a nickel sulfate product, wherein the method comprises introducing nickel particles from a handling device into a vessel comprising a separation device therein and reacting the nickel particles with sulfuric acid, hydrogen peroxide, water, and any combinations thereof, to form the nickel sulfate product.

In some embodiments, the handling device controls the introduction of nickel particles into the vessel. In some embodiments, the handling device is a rotary feeder. In some embodiments, the handling device is a vibrating feeder. In some embodiments, the handling device is a mechanical feeder. In some embodiments, the handling device is a centrifugal feeder. In some embodiments, the handling device is a hopper.

In some embodiments, the separation device comprises a plate with orifices for allowing smaller nickel particles and nickel sulfate solution to pass through while retaining nickel particles of a larger size. In some embodiments, the separation device is a grid. In some embodiments the separation device is a filtering device. In some embodiments the separation device is a packed bed of solids. In some embodiments the separation device is one or more filter candles. In some embodiments the separation device is a weir. In some embodiments the separation device is a lamellar separator. In some embodiments, the separation device is made of plastic. In some embodiments, the separation device is a sieve.

In some embodiments, the sulfuric acid solution comprises water which can be protonated or unprotonated. In some embodiments, the water content of the sulfuric acid is in the range of from 2% to 95% by weight, based on sulfuric acid. In some embodiments, the water content of the sulfuric acid is in the range of from 15% to 30% by weight, based on sulfuric acid. In some embodiments, the concentration of the sulfuric acid chosen is dependent on the concentration of the nickel sulfate solution being targeted.

In some embodiments, the hydrogen peroxide solution comprises water which can be protonated or unprotonated. In some embodiments, the water content of the hydrogen peroxide solution is in the range of from 5% to 95% by weight, based on hydrogen peroxide. In some embodiments, the water content of the hydrogen peroxide is in the range of from 15% to 30% by weight, based on hydrogen peroxide. In some embodiments, the hydrogen peroxide solution is a wt. % solution. In some embodiments, the concentration of the hydrogen peroxide chosen is dependent on the concentration of the nickel sulfate solution being targeted.

In some embodiments, the sulfuric acid solution and the hydrogen peroxide solution are pre-mixed before introduction into the vessel. In some embodiments, the sulfuric acid solution and the hydrogen peroxide solution are introduced separately into the vessel.

In some embodiments, the elemental nickel particles are of irregular shapes and sizes. In some embodiments, the elemental nickel particles have uniform shapes and sizes. In some embodiments, the elemental nickel particles are in the form of lumps. In some embodiments, the elemental nickel particles are in the form of turnings. In some embodiments, the elemental nickel particles are in the form of pellets. In some embodiments, the elemental nickel particles are in the form of rounds. In some embodiments, the elemental nickel particles are in the form of cathodes. In some embodiments, the elemental nickel particles are in the form of electrode fragments. In some embodiments, the elemental nickel particles are in the form of briquettes. In some embodiments, the elemental nickel particles are in the form of powder. In some embodiments, the elemental nickel particles are in the form of a combination of one or more of pellets, rounds, cathodes, briquettes, and powders. In some embodiments, the briquettes are made up of powder and/or fragments that are combined with a binder to form briquettes. In some embodiments, the nickel particles are introduced in a liquid form. In some embodiments the nickel particles are introduced as a liquid containing nickel particles. In some embodiments, the nickel particles are introduced as a liquid containing nickel/nickel oxide (Ni/NiO) particles.

In some embodiments, the nickel lumps have a length, width and height in the range from 5 mm to 10 cm. In some embodiments, the nickel turnings have a thickness in the range from 0.1 mm to 1 mm, a width in the range from 1 mm to 5 mm and a length in the range from 1 cm to 20 cm. In some embodiments, the nickel briquettes have a length in the range from 2 cm to 4 cm and a height in the range from 15 mm to 25 mm. In some embodiments, the nickel electrode fragments have a thickness in the range from 0.5 mm to 7 mm. In some embodiments, the nickel electrode fragments have a thickness in the range from 1 mm to 10 mm. In some embodiments, uncut nickel electrode fragments have a thickness in the range from 1 mm to 3 mm and irregular cross sections, with the diameter at the broadest place not exceeding 40 mm and the average diameter being in the range from 10 mm to 30 mm. In some embodiments, cut nickel electrodes have a thickness in the range from 0.5 mm to 7 mm. In some embodiments, the size of the nickel electrodes is 10 cm×10 cm×1 cm. In some embodiments, the nickel powder has a d₅₀ of 10 μm to 150 μm; d₅₀ herein refers to a median particle diameter or median particle size.

In some embodiments, the nickel particles are reduced in size to form a nickel sulfate slurry. In some embodiments, the nickel particles react with the sulfuric acid and hydrogen peroxide solutions to form a nickel sulfate solution. In some embodiments, the nickel particles are reduced in size to form a nickel sulfate slurry and react with the sulfuric acid and hydrogen peroxide solutions to form a nickel sulfate solution.

The nickel sulfate slurry and/or the nickel sulfate solution are transferred out of the vessel at one end, into an external circulation loop and back into the vessel at an opposite end through the external circulation loop. In some embodiments, the nickel sulfate slurry and/or the nickel sulfate solution are transferred out of the vessel at the bottom end, into an external circulation loop and back into the vessel at the top end through the external circulation loop. In some embodiments, the nickel sulfate slurry and/or the nickel sulfate solution are transferred out of the vessel at the top end, into an external circulation loop and back into the vessel at a bottom end through the external circulation loop.

In some embodiments, the nickel sulfate slurry and/or the nickel sulfate solution are continuously circulated through the vessel and external circulation loop until the nickel sulfate product is ready for collection. In some embodiments, the method further comprises filtering the nickel sulfate slurry, nickel sulfate solution, or any combination thereof, to collect the nickel sulfate product when it is ready for collection using a filtration device.

In some embodiments, the method further comprises pumping the nickel sulfate slurry and/or the nickel sulfate solution through the external circulation loop using one or more pumps. In some embodiments, the pumps are external to the vessel. In some embodiments, the pumps are internal to the vessel.

In some embodiments, the nickel sulfate slurry, the nickel sulfate solution, or a combination of the two, are transferred from the vessel via an outlet in the external loop and into a second reaction vessel for further processing. In some embodiments, the nickel sulfate slurry, the nickel sulfate solution, or a combination of the two is transferred into a top section of the second vessel. In some embodiments, the nickel sulfate slurry, the nickel sulfate solution, or a combination of the two is transferred into a bottom section of the second vessel. In some embodiments, the second vessel comprises a multi-stage stirrer. In some embodiments, the second vessel is optionally charged with additional nickel particles, sulfuric acid solution, and/or hydrogen peroxide solution. In some embodiments, the nickel sulfate solution in the secondary vessel is recycled from the top of the second vessel to the bottom via a pump. In some embodiments, the nickel sulfate solution in the second vessel is recycled from the bottom of the second vessel to the top via a pump. In some embodiments, the second vessel comprises a second external loop. In some embodiments, the second external loop comprises a second outlet for discharging the nickel sulfate product to be collected.

In some embodiments, the nickel sulfate slurry, nickel sulfate solution, or any combination thereof, is further mixed in the second vessel with a multi-stage stirrer in the second vessel. In some embodiments, the second vessel is further charged with additional sulfuric acid, additional hydrogen peroxide, or any combination thereof.

In some embodiments, the method comprises sampling the nickel sulfate slurry, the nickel sulfate solution or any combination thereof during the reaction. In some embodiments, the sampling comprises measuring the concentration of the nickel sulfate slurry, the nickel sulfate solution, or any combination thereof.

In some embodiments, the sampling comprises measuring the pH of the nickel sulfate slurry, the nickel sulfate solution, or any combination thereof. In some embodiments, the sampling comprises measuring the average particle size of the nickel particles in the nickel sulfate slurry, the nickel sulfate solution, or any combination thereof.

In some embodiments, a temperature of the nickel sulfate slurry and/or the nickel sulfate solution are measured using one or more temperature probes or equivalents thereof. In some embodiments, the temperature of the nickel sulfate slurry and/or the nickel sulfate solution is adjusted using one or more heat exchange devices. In some embodiments, the heat exchanges devices is a cooling device. In some embodiments, the heat exchange device is a heating device. In some embodiments, the heat exchange devices comprise a heating device and a cooling device.

In some embodiments, the method is carried out at a temperature ranging from 40° C. to 200° C. In some embodiments, the method is carried out at a temperature ranging from 50° C. to 180° C. In some embodiments, the method is carried out at a temperature ranging from 60° C. to 160° C. In some embodiments, the method is carried out at a temperature ranging from 70° C. to 140° C. In some embodiments, the method is carried out at a temperature ranging from 80° C. to 120° C. In some embodiments, the method is carried out at a temperature of 80° C. In some embodiments, the method is carried out at a temperature of 90° C. In some embodiments, the method is carried out at a temperature of 100° C. In some embodiments, the method is carried out at a temperature of 110° C. In some embodiments, the method is carried out at a temperature of 120° C.

In some embodiments, the method is carried out at ambient pressure. In some embodiments, the method is carried out at a pressure above ambient pressure. In some embodiments, the method is carried out under an inert atmosphere using an inertization gas. In some embodiments, the inertization gas is chosen from water vapor, nitrogen, argon, and combinations thereof. In some embodiments, the inertization gas is water vapor. In some embodiments, the inertization gas is nitrogen. In some embodiments the inertization gas is argon. In some embodiments, the inertization gas is introduced into the headspace of the vessel. In some embodiments, the inertization gas is introduced into the reaction mixture. In some embodiments, the inertization gas is introduced in an area below the separation device. In some embodiments, the inertization gas is introduced in an area above the separation device.

In some embodiments, the nickel sulfate product has an Ni²⁺ concentration ranging between 70 g/l and 200 g/l. In some embodiments, nickel sulfate product has an Ni²⁺ concentration ranging between 90 g/l and 150 g/l. In some embodiments, the nickel sulfate product has an Ni²⁺ concentration ranging between 100 g/l and 140 g/l. In some embodiments, the nickel sulfate product has an Ni²⁺ concentration of 110 g/l. In some embodiments, the nickel sulfate product has an Ni²⁺ concentration of 118 g/l. In some embodiments, the nickel sulfate product has an Ni²⁺ concentration of 120 g/l. In some embodiments, the nickel sulfate product has an Ni²⁺ concentration of 130 g/l. In some embodiments, the nickel sulfate product has an Ni²⁺ concentration of 140 g/l. In some embodiments, the nickel sulfate product has an Ni²⁺ concentration of 120 g/l.

In some embodiments, the nickel sulfate product has pH ranging from 0 to 4. In some embodiments, the nickel sulfate product has pH ranging from 0.5 to 3.5. In some embodiments, the nickel sulfate product has pH ranging from 1.0 to 3.0. In some embodiments, the nickel sulfate product has pH ranging from 1.5 to 2.5. In some embodiments, the nickel sulfate product has pH of 1. In some embodiments, the nickel sulfate product has pH of 2. In some embodiments, the nickel sulfate product has pH of 3. In some embodiments, the nickel sulfate product has pH of 4. In some embodiments, the nickel sulfate product has pH ranging from 2 to 4. In some embodiments, the nickel sulfate product has pH ranging from 2.2 to 3.8. In some embodiments, the nickel sulfate product has pH ranging from 2.4 to 3.6. In some embodiments, the nickel sulfate product has pH ranging from 2.5 to 3.5. In some embodiments, the nickel sulfate product has pH of 2.5. In some embodiments, the nickel sulfate product has pH of 2.6. In some embodiments, the nickel sulfate product has pH of 2.7. In some embodiments, the nickel sulfate product has pH of 2.8. In some embodiments, the nickel sulfate product has pH of 2.9. In some embodiments, the nickel sulfate product has pH of 3.0. In some embodiments, the pH depends on the concentration of the dosed sulfuric acid. In some embodiments, the pH is measured using a glass electrode. In some embodiments, the pH is measured using a combination electrode.

In some embodiments, the nickel sulfate product is filtered over active carbon to remove organic compounds. In some embodiments, the nickel sulfate product is filtered over active carbon to remove excess hydrogen peroxide. In some embodiment, the nickel sulfate product is subjected to iminodiacetic acid based ion exchange to remove Fe³⁺ ions. In some embodiments, the nickel sulfate product is subjected to aminophosphonic acid based ion exchange to remove Fe³⁺ ions. In some embodiments, the nickel sulfate product is subjected to aminomethylphosphonic acid based ion exchange to remove Fe³⁺ ions. In some embodiments, the organic compounds are binders from the nickel briquettes. In some embodiments, after the filtering of the nickel sulfate solution to produce the nickel sulfate product, a further purification is not needed. The purification or the degree of purified nickel sulfate product is dependent on several factors. For example, the purity of the starting materials, i.e., the elemental nickel, sulfuric acid, and hydrogen peroxide, and water and the continued influx of one or more of these materials into the process. The purity of the nickel sulfate product ranges from 50% to 100%. In some embodiments, the purity of the nickel sulfate product ranges from 95% to 100%. In some embodiments, the purity of the nickel sulfate product ranges from 98% to 100%.

In some embodiments, the nickel sulfate product of the present disclosure is suitable for use without further purification.

### Systems

The present disclosure also provides for a system for preparing a nickel sulfate product, wherein the system comprises a first reaction vessel with a separation device therein for controlling the flow of nickel particles therethrough; a handling device for introducing the nickel particles into the vessel; gas inlets for introducing an inertization gas, liquid inlets for introducing sulfuric acid and hydrogen peroxide solutions into the vessel; and a first external circulation loop for circulating the reaction mixture. The system further comprises a second reaction vessel for further processing of the nickel sulfate slurry, nickel sulfate solution, or a combination of the two.

The system comprises handling devices which control the introduction of nickel particles into the first reaction vessel and the second reaction vessel, respectively. In some embodiments, the handling device is a rotary feeder. In some embodiments, the handling device is a vibrating feeder. In some embodiments, the handling device is a mechanical feeder. In some embodiments, the handling device is a centrifugal feeder. In some embodiments, the handling device is a hopper.

The separation device in the first reaction vessel is configured to hold back larger nickel particles, while allowing smaller nickel particles to pass through. The larger nickel particles can further react with the sulfuric acid and hydrogen peroxide solutions to form further nickel sulfate slurry and/or nickel sulfate solution thereby reducing in size so as to eventually pass through the separation device.

In some embodiments, the separation device in the first reaction vessel comprises a plate with orifices. In some embodiments, the separation device in the vessel comprises a grid. In some embodiments, the separation device in the vessel comprises a sieve. In some embodiments, the separation device in the vessel comprises a filtering device. In some embodiments, the separation device in the vessel comprises a packed bed of solids. In some embodiments, the separation device in the vessel comprises one or more filter candles. In some embodiments, the separation device in the vessel comprises a weir. In some embodiments, the separation device in the vessel comprises a lamellar separator. In some embodiments, the separation device in the vessel comprises a combination of the aforementioned devices. In some embodiments, the separation device is made of plastic.

The first reaction vessel is configured to receive nickel particles to form a fixed-bed of the nickel particles with the separation device. In some embodiments, the nickel metal particles are configured as one single bed in the vessel. In some embodiments, the nickel metal particles are configured as multiple beds in their own shells within the vessel. In some embodiments, the nickel metal particles are configured as several horizontal beds. In some embodiments, the nickel metal particles are configured as several parallel packed tubes.

In some embodiments, the vessels are made of epoxy resins, unfilled or filled with glass fibers. In some embodiments, the vessels are laminated epoxy-glass fiber materials. In some embodiments, the vessels are plastics such as polypropylene, PVC or PVDF, and also plastic tubing introduced into steel outers. In some embodiments, the vessels are made of lead or lead alloys. In some embodiments, the vessels are metal vessels such as steel. In some embodiments, the steel vessels are lined with the abovementioned material.

The system further comprises one or more pumps for pumping the nickel sulfate slurry and the nickel sulfate solution through the first external circulation loop. In some embodiments, the pumps are external to the vessel.

In some embodiments, the system further comprises one or more temperature probes for measuring a temperature of the nickel sulfate slurry, the nickel sulfate solution, or any combination thereof.

In some embodiments, the system further comprises one or more heat exchange devices for adjusting the temperature of the nickel sulfate slurry, the nickel sulfate solution, or any combination thereof. In some embodiments, the heat exchange devices are external to the vessel. In some embodiments, the one or more heat exchange devices comprises a cooling device. In some embodiments, the one or more heat exchange devices comprises a heating device.

The system further comprises a second reaction vessel to collect the nickel sulfate slurry, the nickel sulfate solution, or any combination thereof for further processing before the nickel sulfate product is collected. In some embodiments, the second reaction vessel further comprises a multistate stirrer for further mixing the nickel sulfate slurry, nickel sulfate solution, or any combination thereof. The second reaction vessel features liquid inlets for further charging the secondary vessel with additional sulfuric acid, additional hydrogen peroxide, water, or any combination thereof.

The second reaction vessel is configured to be charged with additional nickel powder, sulfuric acid solution, and/or hydrogen peroxide solution. The second reaction vessel is configured to recycle nickel sulfate solution from one end of the second reaction vessel to the opposite end. In some embodiments, the second reaction vessel is configured to recycle nickel sulfate solution from the top of the second reaction vessel to the bottom via a pump. In some embodiments, the second reaction vessel is configured to recycle nickel sulfate solution from the bottom of the second reaction vessel to the top via a pump. The second reaction vessel comprises a second external loop. The second external loop comprises a second outlet for discharging the nickel sulfate product to be collected.

In some embodiments, the system further comprises one or more sampling ports for sampling the nickel sulfate slurry, the nickel sulfate solution or any combination thereof during the reaction. In some embodiments, the sampling comprises measuring the concentration of the nickel sulfate slurry, the nickel sulfate solution, or any combination thereof. In some embodiments, the sampling comprises measuring the pH of the nickel sulfate slurry, the nickel sulfate solution, or any combination thereof. In some embodiments, the sampling comprises measuring the average particle size of the nickel particles in the nickel sulfate slurry, the nickel sulfate solution, or any combination thereof.

In some embodiments, the system further comprises a filtering device for filtering the nickel sulfate slurry, nickel sulfate solution, or any combination thereof, to collect the nickel sulfate product when it is ready for collection. In some embodiments, the system comprises a filter for filtering the nickel sulfate solution to produce the nickel sulfate product and to remove fine particles remaining. In some embodiments, the filter is a cross flow filter. In some embodiments, the filter is a membrane filter.

Before describing exemplary embodiments of the present disclosure, it is to be understood that the disclosure is not limited to the details of construction or process steps set forth in the following examples and is capable of other embodiments and of being practiced or being carried out in various ways.

### EXAMPLES

The following examples are intended to be illustrative and are not meant in any way to limit the scope of the disclosure.

### 1-Stage Set-Up for Producing a Nickel Sulfate Product:

As shown in FIGS. 1a and 1b, in a one-stage process, a handling device (1) containing nickel particles of one or more shapes and sizes can be used to charge a reaction vessel (2) with the nickel particles to form a fixed bed (3) on a separating device, such as a grid (4). The fixed bed (3) comprises particles arranged in a size gradient, i.e., with larger particles at the end of the bed and gradually decreasing in size to the opposite end, with the smaller particles at the opposite end. The vessel (2) is then filled with a liquid medium, such as water, which is circulated in a recycle from one end of the vessel (2) and into an opposite end of the vessel using a pump (5), through an external loop (6) and a heat exchanger (7).

An inertization gas (8) can be used to fill the head of the vessel, such as nitrogen, argon, or steam. The mixture is heated to 75° C., at ambient pressure. Sulfuric acid (9) and hydrogen peroxide (10) can be continuously dosed via one or more inlets at one or several locations on vessel (2) in a way to achieve a nickel sulfate solution with a predetermined nickel concentration. The reactor (2) is continuously charged with nickel material from the handling device (1).

In one embodiment, as shown in FIG. 1a, the reaction mixture is circulated from the top of the vessel (2) to the bottom. As the nickel metal, sulfuric acid, and hydrogen peroxide react, the nickel particles reduce in size and move along the nickel bed gradient (3), and are eventually small enough to pass though the separation device (4), in the form of a nickel sulfate slurry, a nickel sulfate solution, or a combination of the two (11). The nickel sulfate product is discharged from the vessel via an outlet (12) in the external loop (6) and collected.

In another embodiment, as shown in FIG. 1b, the reaction mixture is circulated from the bottom of the vessel (2) to the top. As the nickel metal, sulfuric acid, and hydrogen peroxide move along the nickel bed gradient (3), and are pumped to the top of the nickel bed (3) by means of a liquid distributor (13), in the form of a nickel sulfate slurry, a nickel sulfate solution, or a combination of the two (11). The nickel sulfate product is discharged from the vessel via an outlet (12) in the external loop (6) for collection.

### 2-Stage Set-Up for Producing a Nickel Sulfate Product:

As shown in FIG. 2, in a two-stage process, in the first stage, a handling device (20) containing nickel particles of one or more shapes and sizes can be used to charge a first reaction vessel (21) with the nickel particles to form a fixed bed (22) on a separating device, such as candle filters (23). Nickel sulfate slurry, nickel sulfate solution, or a combination of the two, containing fines (24) is recycled from the bottom of the first reaction vessel (21) through a first external loop (25) via a pump (26) and through a heat exchanger (27) to the top of the first reaction vessel (21). The mixture is heated to 75° C. Sulfuric acid (28), hydrogen peroxide (29) and water (30) are continuously dosed into the first reaction vessel (21) via three separate inlets, positioned at the upper part of the external loop (25). Part of the slurry is discharged from the first reaction vessel (21) via the external loop (25) into the bottom of a second reaction vessel (31) containing a multi-stage stirrer (32). The second reaction vessel (31) can optionally be charged with additional nickel powder via a handling device (20). Sulfuric acid (28) and hydrogen peroxide (29) can optionally be dosed via separate inlets directly into the second reaction vessel (31). Nickel sulfate solution is recycled from the top of the vessel (31) to the bottom via a pump through a separation device (not shown) and a heat exchanger (33). Nickel product solution is discharged from the second reaction vessel (31) via an outlet (34) in a second external loop (35) to be collected.

### LIST OF REFERENCE SIGNS

1 handling device
2 reaction vessel
3 fixed bed
4 grid
5 pump
6 external loop
7 heat exchanger
8 inertization gas
9 sulfuric acid
10 hydrogen peroxide
11 nickel sulfate slurry and/or nickel sulfate solution
12 outlet
13 liquid distributor
20 handling device
21 primary reaction vessel
22 fixed bed
23 candle filters
24 nickel sulfate slurry and/or nickel sulfate solution containing fines
25 first external loop
26 pump
27 heat exchanger
28 sulfuric acid
29 hydrogen peroxide
30 water
31 second reaction vessel
32 multi-stage stirrer
33 heat exchanger
34 outlet
35 second external loop

1. A method for preparing a nickel sulfate product, the method comprising
introducing nickel particles from a handling device (1, 20) into a vessel (2, 21) comprising a separation device (4, 23) therein, wherein the separation device (4, 23) controls the flow of the nickel particles through the vessel (2, 21), and the nickel particles form a fixed bed (3, 22) on the separation device (4, 23);
introducing an inertization gas (8) into the vessel (2, 21) through one or more gas inlets;
introducing a sulfuric acid solution (9, 28) into the vessel (2, 21) through one or more liquid inlets;
introducing a hydrogen peroxide solution (10, 29) into the vessel (2, 21) through one or more liquid inlets;
wherein the sulfuric acid solution (9, 28), the hydrogen peroxide solution (10, 29), and the nickel particles react to reduce the size of the nickel particles to form a nickel sulfate slurry, to dissolve the nickel particles to form a nickel sulfate solution, or any combination thereof (11, 24); wherein the nickel sulfate slurry, the nickel sulfate solution, or any combination thereof (11, 24) pass through the separation device (4, 23); and
transferring the nickel sulfate slurry, the nickel sulfate solution, or any combination thereof (11, 24) out of the vessel (2, 21) at one end into an external circulation loop (6, 25) and back into the vessel (2, 21) at an opposite end through the external circulation loop (6, 25) continuously until the nickel sulfate product is ready for collection.

2. The method according to claim 1, wherein the method further comprises pumping the nickel sulfate slurry, the nickel sulfate solution, or any combination thereof (11, 24) through the external circulation loop (6, 25) using one or more pumps (5, 26), and wherein the pumps (5, 26) are external to the vessel (2, 21).

3. The method according to claim 1, wherein the method further comprises measuring a temperature of the nickel sulfate slurry, the nickel sulfate solution, or any combination thereof (11, 24) using one or more temperature probes, optionally wherein the method further comprises adjusting the temperature of the nickel sulfate slurry, the nickel sulfate solution, or any combination thereof (11, 24) using one or more heat exchange devices (7, 27), and wherein the heat exchange devices (7, 27) are external to the vessel.

4. The method according to claim 3, wherein the one or more heat exchange devices (7, 27) comprises a cooling device, and/or wherein the one or more heat exchange devices (7, 27) comprises a heating device.

5. The method according to claim 1, wherein the inertization gas (8) is chosen from water vapor, nitrogen, argon, and combinations thereof, and/or wherein the nickel particles are in a form chosen from pellets, rounds, cathodes, briquettes, powder, and combinations thereof.

6. The method according to claim 1, wherein the sulfuric acid solution (9, 28) and the hydrogen peroxide solution (10, 29) are pre-mixed before introduction into the vessel (2, 21), and/or wherein the method further comprises filtering the nickel sulfate slurry, nickel sulfate solution, or any combination thereof (11, 24), to collect the nickel sulfate product when it is ready for collection using a filtration device (4, 23).

7. The method according to claim 1, wherein the method further comprises passing the nickel sulfate product over activated carbon to remove residual hydrogen peroxide, or wherein the method further comprises heating the nickel sulfate product to remove residual hydrogen peroxide.

8. The method according to claim 1, wherein the method further comprises removing Fe³⁺ ion by ion exchange.

9. The method according to claim 1, wherein the method is carried out at a temperature ranging from 40° C. to 200° C.

10. The method according to claim 1, wherein the nickel sulfate product has an Ni²⁺ concentration ranging from 70 g/l to 200 g/l and a pH ranging from 0 to 4, or wherein the nickel sulfate product is suitable for use without further purification.

11. A system for preparing a nickel sulfate product, the system comprising:
a first reaction vessel (21) with a separation device (23) therein for controlling the flow of nickel particles therethrough; wherein the first reaction vessel (21) is configured to form a fixed bed (22) of the nickel particles on the separation device (23);
a first handling device (20) for introducing the nickel particles into the first reaction vessel (21);
a first external loop (25);
liquid inlets positioned at the upper part of the first external loop (25) for introducing a sulfuric acid solution (28), a hydrogen peroxide solution (29), and water (30), respectively, into the first reaction vessel (21);
wherein the separation device (23) is configured to let nickel sulfate slurry and/or nickel sulfate solution containing fines (24) pass through and exit the vessel (21) at the bottom and enter the first external loop (25);
wherein the first external loop (25) is configured to transfer the nickel sulfate slurry and/or the nickel sulfate solution containing fines (24) back into the first reaction vessel (21) at the top of the first reaction vessel (21);
wherein the system further comprises one or more pumps (26) for pumping the nickel sulfate slurry and/or the nickel sulfate solution containing fines (24) through the first external circulation loop (25), and wherein the pumps (26) are external to the first reaction vessel (21);
wherein the system further comprises one or more heat exchange devices (27) for adjusting the temperature of the nickel sulfate slurry and/or the nickel sulfate solution containing fines (24), and wherein the heat exchange devices (27) are external to the first reaction vessel (21); and
wherein the system further comprises a second reaction vessel (31), a second handling device (20) for charging the second reaction vessel (31) with additional nickel powder, liquid inlets for dosing sulfuric acid (28) and hydrogen peroxide (29) into the second reaction vessel (31), and a second external loop (35);
wherein the first external loop (25) is configured to discharge part of the nickel sulfate slurry and/or the nickel sulfate solution containing fines (24) from the first reaction vessel (21) into the second reaction vessel (31);
wherein the second external loop (35) is configured to recycle nickel sulfate solution from one end of the second reaction vessel (31) to the other end of the second reaction vessel (31) via a pump through a separation device and a heat exchanger (33); and
wherein the second external loop (35) comprises an outlet (34) for discharging nickel product solution from the second reaction vessel (31).

12. The system of claim 11, wherein the second reaction vessel (31) contains a multi-stage stirrer (32).

13. The system of claim 11, wherein the first external loop (25) is configured to discharge part of the nickel sulfate slurry and/or the nickel sulfate solution containing fines (24) from the first reaction vessel (21) into the bottom of the second reaction vessel (31) and the second external loop (35) is configured to recycle nickel sulfate solution from the top of the second reaction vessel (31) to the bottom of the second reaction vessel (31).

14. The system of claim 11, further comprising a filtering device for filtering the nickel sulfate product and to remove fine particles remaining.

15. The system of claim 14, wherein the filtering device is a membrane filter.
